(19) United States
(12) Patent Application Publication
(10) Pub. No.: US 2017/0174221 A1
(43) Pub. Date: Jun. 22, 2017

(54) MANAGING AUTONOMOUS VEHICLES

(71) Applicants: Robert Lawson Vaughn, Portland, OR (US); Timothy J. Gresham, Portland, OR (US); Corey Kukis, Beaverton, OR (US); John Charles Weast, Portland, OR (US)

(72) Inventors: Robert Lawson Vaughn, Portland, OR (US); Timothy J. Gresham, Portland, OR (US); Corey Kukis, Beaverton, OR (US); John Charles Weast, Portland, OR (US)

(21) Appl. No.: 14/975,035

(22) Filed: Dec. 18, 2015

(51) Int. Cl. B60W 40/09; G05D 1/02

(52) U.S. Cl. CPC B60W 40/09; G05D 1/021

(57) ABSTRACT

Various systems and methods for managing autonomous vehicles are described herein. A system for managing an autonomous vehicle, the system comprises a driving behavior collection module to collect driving behavior of a driver while driving an autonomous vehicle in manual mode; a driving profile module to build a driving profile based on the driving behavior; and a configuration module to configure the autonomous vehicle to operate according to the driving profile when operating in autonomous mode.

### TECHNICAL FIELD

Embodiments described herein generally relate to vehicle controls and in particular, to managing autonomous vehicles.

### BACKGROUND

Autonomous vehicles, also referred to as self-driving cars, driverless cars, unscrewed vehicles, or robotic vehicles, are vehicles capable of replacing traditional vehicles for conventional transportation. Elements of autonomous vehicles have been introduced slowly over the years. Such elements include lane departure warning systems, adaptive cruise control, and self-parking vehicles.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system to control an autonomous vehicle, according to an embodiment;

FIG. 2 is a data flow diagram illustrating a process and system to generate a driver profile, according to an embodiment;

FIG. 3 is a data and control flow diagram illustrating generating driver profiles, according to an embodiment;

FIG. 4 is a flowchart illustrating a method 400 of managing an autonomous vehicle, according to an embodiment; and

FIG. 5 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide mechanisms to manage autonomous vehicles. As vehicles become more autonomous, drivers are given less of an active role in driving. During the transition period before vehicles are fully autonomous, drivers may benefit from systems that acclimate the driver to autonomous operation. Many drivers like the feel of driving or prefer a certain driving style. What is needed is a system to modify autonomous vehicle operations to adaptively operate in a manner similar to that of the driver.

As vehicles become more intelligent, adaptive, and programmable, drivers will expect that just like one may set the position of a seat or the operation of the thermostat and have that information stored in the vehicle, likewise the vehicle should drive in the manner preferred by the driver. Using information obtained while the driver is actively driving an autonomous vehicle, the autonomous vehicle may build a driving profile for the driver and use the driving profile to influence the driving style of the vehicle.

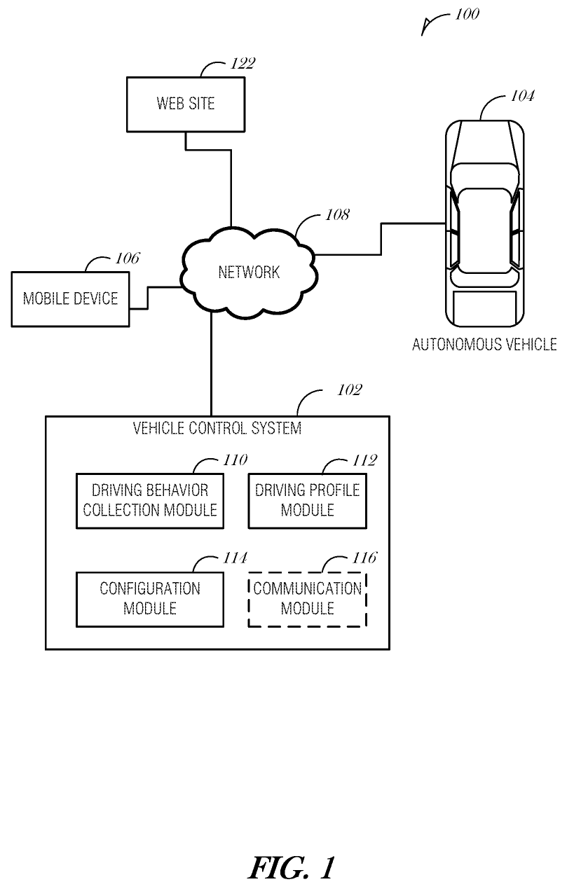

FIG. 1 is a schematic drawing illustrating a system 100 to control an autonomous vehicle, according to an embodiment. FIG. 1 includes a vehicle control system 102, an autonomous vehicle 104, and a mobile device 106, communicatively coupled via a network 108.

The autonomous vehicle 104 may be of any type of vehicle, such as a commercial vehicle, consumer vehicle, or recreation vehicle able to operate at least partially in an autonomous mode. The autonomous vehicle 104 may operate at some times in a manual mode where the driver operates the vehicle 104 conventionally using pedals, steering wheel, and other controls. At other times, the autonomous vehicle 104 may operate in a fully autonomous mode, where the vehicle 104 operates without user intervention. In addition, the autonomous vehicle 104 may operate in a semi-autonomous mode, where the vehicle 104 controls many of the aspects of driving, but the driver may intervene or influence the operation using conventional (e.g., steering wheel) and non-conventional inputs (e.g., voice control).

The autonomous vehicle 104 includes an on-board diagnostics system to record vehicle operation and other aspects of the vehicle's performance, maintenance, or status. The autonomous vehicle 104 may also include various other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like.

The mobile device 106 may be a device such as a smartphone, cellular telephone, mobile phone, laptop computer, tablet computer, or other portable networked device. In general, the mobile device 106 is small and light enough to be considered portable and includes a mechanism to connect to a network, either over a persistent or intermittent connection.

The network 108 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 108 may include a single local area network (LAN) or wide-area network (WAN), or combinations of LANs or WANs, such as the Internet. The various devices (e.g., mobile device 106 or vehicle 104) coupled to the network 108 may be coupled to the network 108 via one or more wired or wireless connections.

In operation, the autonomous vehicle 104 is driven for a period of time, during which the on-board diagnostics system records various vehicle operation data. Vehicle operation data may include, but is not limited to average fuel consumption (e.g., miles per gallon or kilometers per liter), acceleration/deceleration patterns, turning patterns, average vehicle speed, following distance, amount of fuel consumed, emissions, outdoor weather, road conditions, occupant information, vehicle feature use (e.g., anti-lock braking, air bag use, intermittent wipers, dynamic vehicle handling, etc.), and the like. Additional examples of vehicle operation data include performance data related to the driving of the vehicle. For example, speed data, g-load data (e.g., linear or angular acceleration), mileage data, average acceleration, average deceleration, and the like. Vehicle performance data may also include, in further examples, engine performance data, such as, oil temperature, fluid levels, cylinder temperature, spark plug voltage, fuel-air mixture, fuel flow, air pressure, boost pressure (if engine is turbocharged, or supercharged), emissions gas readings, and the like. Vehicle performance metrics may be characterized as data that is collected by the vehicle itself during normal monitoring of its own performance Operational data with respect to driver behavior may be collected by bolt on, or after market, installed units. Data may also be directly read from engine monitoring systems installed by the manufacturer of the vehicle by the mobile device 106 or the vehicle control system 102.

In an embodiment, the vehicle control system 102 includes a driving behavior collection module 110, a driving profile module 112, a configuration module 114, and an optional communication module 118. The vehicle control system 102 operates as a system to create, modify, and manage a driver profile based on measured driver behavior. The driving behavior collection module 110 is operable to receive vehicle operation data for the autonomous vehicle 104 based on the driver's manual operation of the autonomous vehicle 104. In various embodiments, the vehicle operation data comprises a vehicle performance metric or an environmental metric. The vehicle performance metric may comprise a vehicle speed, fuel efficiency, an acceleration, or a deceleration. The environmental metric may comprise a number of occupants in the vehicle, a condition of the road that the vehicle 104 has travelled over, an outside temperature, a weather metric that the vehicle 104 was operated in, or a route that the autonomous vehicle 104 was driven. The vehicle operation data may be received directly from the autonomous vehicle 104. In an alternative embodiment, to receive vehicle operation data for the vehicle, the driving behavior collection module 110 is to receive the vehicle operation data from a user device (e.g., mobile device 102), which obtained the vehicle operation data when communicatively connected to the autonomous vehicle 104. The autonomous vehicle 104 may be any type of vehicle, including but not limited to a car, a truck, a motorcycle, a boat, or a recreational vehicle.

The driving profile module 112 is operable to use the vehicle operation data to identify data describing how the autonomous vehicle 104 was used. For example, the driving profile module 112 may evaluate the vehicle operation data to determine an acceleration/deceleration pattern or determine a turning pattern. Turning patterns refer to the gyrometry (e.g., angular speed) throughout at turn, describing how the vehicle makes a turn. A more aggressive turning pattern may indicate harder, sharper turns, which may indicate a more aggressive driving style. With such information, the driving profile module 112 may build a driving profile based on the driving behavior of the driver.

Other aspects of the autonomous vehicle's operation may be analyzed to compile a driver profile, such as fuel efficiency patterns, occupant patterns (e.g., how often the vehicle is used by the driver to transport other people), usage route patterns, and the like. Seat sensors may be used to determine the number of passengers and their approximate weight, which may identify whether adult occupants or child occupants are present. Other mechanisms may be used to track occupants, such as with the key they use (e.g., by key fob RFID), facial recognition, weight distribution in seats, settings of seat position, etc.

The vehicle control system 102 may be disposed in the autonomous vehicle 104, mobile device 106, or in a network server (e.g., a web site 122). The driver profile may be shared from the web site 122 with one or more other people. For example, a person may want to experience the driving characteristics of a famous person, such as a famous racecar driver, and download the driver profile of that person from the web site 122. The driver profile may then be loaded into a vehicle control system 102 and activated. In this way, a fan of the racecar driver may experience a driving sample of their idol.

Conversely, the driver may upload a driver profile to a remote location (e.g., the web site 122) using the communication module 116. Various social platforms may be formed around driving types, vehicle models, geographical areas, and the like, where people may discuss, share, and examine driving profiles of autonomous vehicles. For example, a Pacific Northwest Ford Mustang driving profiles forum may be formed where owners and fans of Mustangs may converge and discuss driving profiles.

Several profiles may coexist for use by the vehicle control system 102. For example, one profile may be used for track racing and another profile may be used for daily driving. Alternatively, one driver profile may have various rules or constraints such that the vehicle control system 102 manages the autonomous vehicle 104 in a different manner based on the location of the vehicle (e.g., at the track).

Thus, in an embodiment, the vehicle control system 102 provides a system for managing an autonomous vehicle 104, the system comprising a driving behavior collection module 110 to collect driving behavior of a driver while driving the autonomous vehicle 104 in manual mode, a driving profile module 112 to build a driving profile based on the driving behavior, and a configuration module 114 to configure the autonomous vehicle 104 to operate according to the driving profile when operating in autonomous mode.

In an embodiment, to collect driving behavior, the driving behavior collection module 110 is to record a rate of acceleration of the autonomous vehicle 104 from a stopped position and average the rate of acceleration over a time period to obtain an average rate of acceleration.

In an embodiment, to collect driving behavior, the driving behavior collection module 110 is to record a cornering speed of the autonomous vehicle 104 around similar type corners and average the cornering speed over a time period to obtain an average cornering speed for the similar type corners. As used herein, a similar type corner defines a set of corners that, while not identical, are the same when adjusted for a given tolerance. For example, if two corners have different radii, but the radii are with a predefined tolerance, then the corners are in the set of similar type corners. As another example, two 90-degree turns may be considered similar. Thus, similarity refers to two things that are within a predetermined tolerance to each other. It is noted, however, that the tolerance may be changed over time, such as a variance in samples taken over time.

In an embodiment, to build the driving profile, the driving profile module 112 is to for each of a particular driving behavior, create or modify a driving rule that operates the autonomous vehicle 104 in a manner consistent with the particular driving behavior. For example, a list of driving behaviors may be maintained with corresponding rules. The list may include acceleration from stop, deceleration to stop, 90-degree turn characteristics, and following distance. Each of the driving behaviors in the list may be correlated to a parameterized value to indicate the degree or amount of effort used in each behavior. The acceleration from stop behavior may be parameterized as a 0-30 miles per hour period, where 2.5 seconds is considered aggressive and 4.0 seconds is considered conservative driving behavior. Using the driver's own behaviors, the driver profile may be configured with a rule to use acceleration from stop times of 3.2 seconds.

In an embodiment, to configure the autonomous vehicle 104 to operate according to the driving profile when operating in autonomous mode, the configuration module 114 is to adjust the operation of the autonomous vehicle 104 according to a context of the operation. Context is a large factor when driving. For example, one may not drive as fast on snow or ice as when driving on dry roads; one may not brake as aggressively with elderly passengers in the vehicle; or one may not drive aggressively when someone is feeling nauseous. Thus, in an embodiment, to adjust the operation of the autonomous vehicle 104 according to the context of the operation, the configuration module 114 is to determine the context of the operation from an appointment calendar of the driver and based on an entry in the appointment calendar, adjust the operation of the autonomous vehicle 104. When a person is running late to a meeting, the autonomous vehicle 104 may be configured to drive a bit faster or wait a bit less at a stop sign, for example.

In an embodiment, to adjust the operation of the autonomous vehicle 104 according to the context of the operation, the configuration module 114 is to determine the context of the operation from a behavior of an occupant of the autonomous vehicle 104 and based on the behavior of the occupant, adjust the operation of the autonomous vehicle 104. Use of biometric sensors, such as cameras with posture recognition, facial recognition, or microphones with speech recognition, may determine that someone is feeling ill, uncomfortable, or uneasy about the vehicle's operation. Thus, in an embodiment, the behavior of the occupant indicates that the occupant is in pain, and to adjust the operation of the autonomous vehicle 104, the configuration module 114 is to decrease at least one of: an average speed, an average cornering speed, or an average braking speed.

In another embodiment, the behavior of the occupant indicates that the occupant is nervous, and to adjust the operation of the autonomous vehicle 104, the configuration module 114 is to decrease at least one of: an average speed, an average cornering speed, or an average braking speed.

In another embodiment, to determine the context of the operation from the behavior of the occupant of the autonomous vehicle 104, the configuration module is to measure the behavior of the occupant using an in-vehicle sensor. Various in-vehicle sensors may be used, such as cameras, floorboard sensors to detect pressure from occupants' feet (e.g., it is a natural reaction to brace one's self during aggressive driving), heart rate monitors, and the like. In an embodiment, the in-vehicle sensor comprises a camera, and wherein to measure the behavior of the occupant, the configuration module 114 is to identify a facial expression, posture, or bodily reaction to an operation of the autonomous vehicle 104 and correlate the facial expression, posture, or bodily reaction to the behavior. In another embodiment, the in-vehicle sensor comprises floorboard pressure sensors and to measure the behavior of the occupant, the configuration module 114 is to identify a pressure profile to an operation of the autonomous vehicle 104 and correlate the pressure profile to the behavior. While some pressure is expected during braking, excessive pressure or pressure detected during other maneuvers may indicate that the occupant is nervous or frightened.

In an embodiment, the in-vehicle sensor comprises a microphone and wherein to measure the behavior of the occupant, the configuration module 114 is to identify an utterance of the occupant and correlate the utterance to the behavior. For example, an occupant may exclaim “whoa!” or “jeez” to indicate that the driving is too aggressive, or “boring” if the driving is too passive.

In an embodiment, to adjust the operation of the autonomous vehicle 104 according to the context of the operation, the configuration module 114 is to determine the context of the operation from an identity of an occupant of the autonomous vehicle 104 and based on the identity of the occupant, adjust the operation of the autonomous vehicle 104. The occupant's identity may be determined using cameras with facial recognition software, a key fob, a uniquely paired device, or other mechanisms. Some occupants may not enjoy the same driving styles as the driver. For example, Grandma may not like how her grandson drives. In such cases, the configuration module 114 may adjust the operating characteristics of the autonomous vehicle 104 to better suit the occupants.

In an embodiment, to adjust the operation of the autonomous vehicle 104 according to the context of the operation, the configuration module is to determine the context of the operation from a state of the autonomous vehicle 104 and based on the state, adjust the operation of the autonomous vehicle 104. In various embodiments, the state of the autonomous vehicle 104 comprises a current tow weight, and to adjust the operation of the autonomous vehicle 104, the configuration module 114 is to decrease at least one of: an average speed, an average cornering speed, or an average braking speed. The state of the autonomous vehicle 104 may include environmental operating data, such as at least one of: a time of day, a road condition, a traffic condition, or a location. Thus, the autonomous vehicle 104 may take into consideration the vehicle's own use, state, or condition along with external environmental factors, such as weather or road condition.

In an embodiment, the communication module 116 may transmit the driving profile to a driving profile server, the driving profile server remote from the autonomous vehicle 104 and configured to share the driving profile with other drivers. The communication module 116 may transmit a portion of the driving profile to the driving profile server (e.g., to share acceleration characteristics of a driver, but not following patterns).

In an embodiment, the driving profile module 112 is to modify the driving profile while the autonomous vehicle 104 is operating in autonomous mode, and the configuration module 114 is to configure the autonomous vehicle 104 to operate according to the driving profile when operating in autonomous mode. Thus, in such an embodiment, the driving profile is constantly revised based on the driver's own manual driving style and also in view of the driver's reactions (and possibly other occupants' reactions) when the vehicle is driving itself.

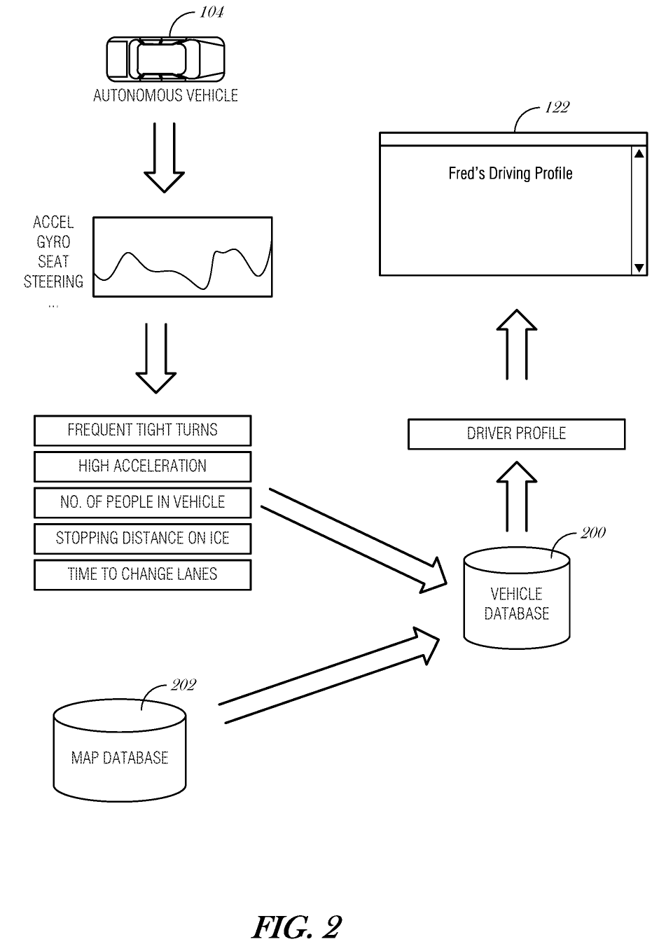

FIG. 2 is a data flow diagram illustrating a process and system to generate a driver profile, according to an embodiment. Data is collected from operation of the autonomous vehicle 104. The data may be related to the vehicle's performance, such as acceleration, deceleration, gyrometer, seat sensor data, steering data, and the like. The data may also be related to the vehicle's occupants, operating environment, use, or the like. The data may be collected and trended over time (e.g., average speed or average acceleration from a stop). The data may be collected and transmitted to a vehicle database 200.

To mitigate privacy issues, one or more mechanisms may be used. First, the driver, the vehicle, or the location may be anonymized. Instead of transferring data that describes a particular vehicle, driver, or location, the data may be generalized or otherwise obscured. Another mechanism that may be used to mitigate privacy issues is to process data locally as much as possible. For example, using an on-board system, the data may be analyzed, summarized, or otherwise processed to produce only statistical results.

Various data may be collected and transferred to the vehicle database 200. Data indicating an aggressive or sporty driving style, such as frequent tight turns, high acceleration, and short time to change lanes, may be collected and transmitted. Other data indicating a more passive or leisurely driving style, such as a slower average speed, longer braking distances, longer following distances, and the like, may be transmitted. In addition, other data may be collected and analyzed in order to directly measure or indirectly infer various qualities of how the vehicle is used. A few characteristics and qualities are provided here.

Indications of an aggressive or sport-oriented driver include using an accelerometer/gyrometer to detect tight turns, winding roads, high acceleration, and quick stops. Global positioning systems (GPS) and road maps may be correlated with vehicle speed to determine how often the vehicle is driven at or near the speed limit. Road maps may be provided by a map database 204. The map database 204 may be incorporated into the on-board system in a vehicle or may be provided by an external service.

Indications of a passive or leisurely driver include accelerometer, gyrometer, steering wheel, brake, or turn signal data that infers or indicates slower changes in speed and direction, longer time between the start of the turn signal and the turn itself, longer following distances, longer braking distances before a turn, and the like. With road maps and GPS, length of time at stop lights and stop signs may be measured, acceleration/deceleration around turns, as well as the relationship between speed limit and typical speed the vehicle is driven.

The vehicle database 200 may be used to supply data to a web site or other interactive online resource. For example, the vehicle database 200 may be used to compare drivers' profiles across several vehicles of the same type to determine baseline driver characteristics and operating tolerances for a particular vehicle.

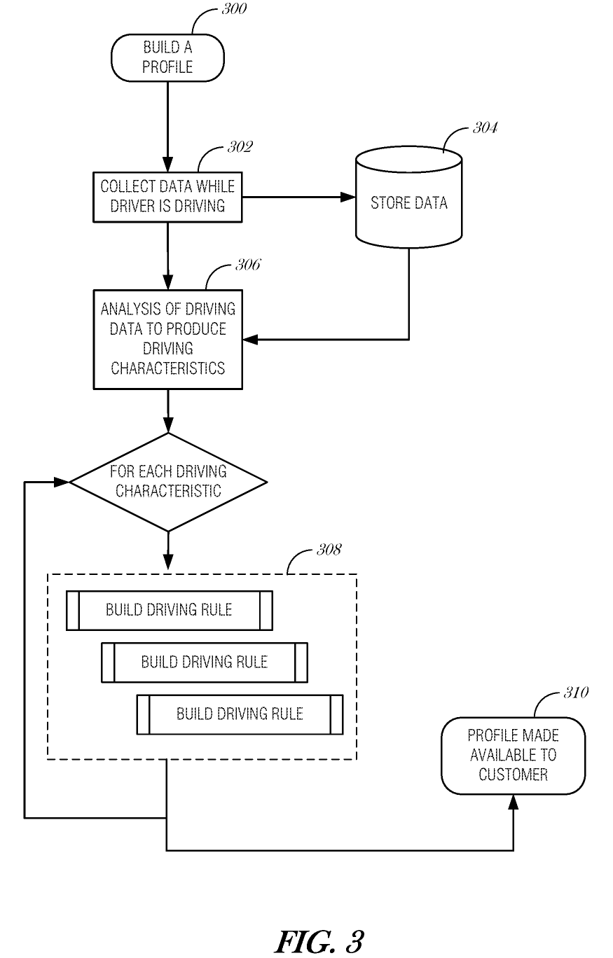

FIG. 3 is a data and control flow diagram illustrating generating driver profiles, according to an embodiment. At operation 300, the data and control flow initiate to build a driving profile. Data is collected while the driver is driving (operation 302) and the data is stored (operation 304). The data is analyzed to produce driving characteristics (operation 306). For each driving characteristic, a driving rule is built (operation 308). Characteristics may be acceleration from stop, deceleration to stop, and the like. A driving rule may be a parameterized value used to operate an autonomous vehicle consistent with the underlying associated characteristic. After the driving rules are built, the rules are compiled into a profile, which is then provided to a customer (e.g., the driver) at operation 310. Driving rules and driver/vehicle behavior may be used in various machine learning algorithms to determine a driving profile.

Other aspects of the system are understood to be within the scope of this disclosure. For example, a loop back capability to the profile creation process may be implemented so that every time the driver (e.g., customer) switches back to manual driving it tweaks the profile based on learned observations. This allows for a profile to continuously change. As an example, “as I get older my driving style relaxes so does the autonomous operation, etc.” The guidance or feedback may be provided using a mobile user device (e.g., device 106). As another example, if the autonomous car takes over and driver monitoring suggests that the driver or passengers are uncomfortable with how the car is “driving” then that information could also be used to adjust the profile selected for the (psychological) comfort of the passengers.

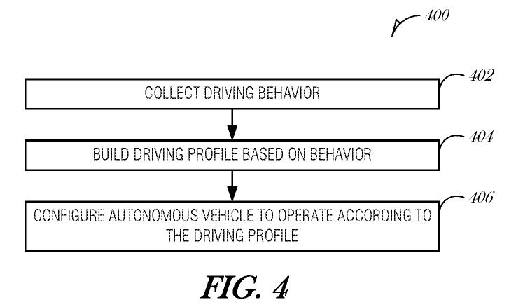

FIG. 4 is a flowchart illustrating a method 400 of managing an autonomous vehicle, according to an embodiment. At block 402, driving behavior of a driver while driving an autonomous vehicle in manual mode is collected. In an embodiment, collecting driving behavior comprises recording a rate of acceleration of the autonomous vehicle from a stopped position and averaging the rate of acceleration over a time period to obtain an average rate of acceleration. In an embodiment, collecting driving behavior comprises recording a cornering speed of the autonomous vehicle around similar type corners and averaging the cornering speed over a time period to obtain an average cornering speed for the similar type corners.

At block 404, a driving profile is built based on the driving behavior. In an embodiment, building the driving profile comprises for each of a particular driving behavior, creating or modifying a driving rule that operates the autonomous vehicle in a manner consistent with the particular driving behavior.

At block 406, the autonomous vehicle is configured to operate according to the driving profile when operating in autonomous mode.

In an embodiment, configuring the autonomous vehicle to operate according to the driving profile when operating in autonomous mode comprises adjusting the operation of the autonomous vehicle according to a context of the operation. In a further embodiment, adjusting the operation of the autonomous vehicle according to the context of the operation comprises determining the context of the operation from an appointment calendar of the driver and based on an entry in the appointment calendar, adjusting the operation of the autonomous vehicle.

In another embodiment, adjusting the operation of the autonomous vehicle according to the context of the operation comprises determining the context of the operation from a behavior of an occupant of the autonomous vehicle and based on the behavior of the occupant, adjusting the operation of the autonomous vehicle. In a further embodiment, the behavior of the occupant indicates that the occupant is in pain, and adjusting the operation of the autonomous vehicle comprises decreasing at least one of: an average speed, an average cornering speed, or an average braking speed. In another embodiment, the behavior of the occupant indicates that the occupant is nervous, and adjusting the operation of the autonomous vehicle comprises decreasing at least one of: an average speed, an average cornering speed, or an average braking speed.

In an embodiment, determining the context of the operation from the behavior of the occupant of the autonomous vehicle comprises measuring the behavior of the occupant using an in-vehicle sensor. In a further embodiment, the in-vehicle sensor comprises a camera, and measuring the behavior of the occupant comprises identifying a facial expression, posture, or bodily reaction to an operation of the autonomous vehicle and correlating the facial expression, posture, or bodily reaction to the behavior. In another embodiment, the in-vehicle sensor comprises floorboard pressure sensors and measuring the behavior of the occupant comprises identifying a pressure profile to an operation of the autonomous vehicle and correlating the pressure profile to the behavior. In another embodiment, the in-vehicle sensor comprises a microphone and measuring the behavior of the occupant comprises identifying an utterance of the occupant and correlating the utterance to the behavior.

In an embodiment, adjusting the operation of the autonomous vehicle according to the context of the operation comprises determining the context of the operation from an identity of an occupant of the autonomous vehicle and based on the identity of the occupant, adjusting the operation of the autonomous vehicle.

In an embodiment, adjusting the operation of the autonomous vehicle according to the context of the operation comprises determining the context of the operation from a state of the autonomous vehicle and based on the state, adjusting the operation of the autonomous vehicle. In a further embodiment, the state of the autonomous vehicle comprises a current tow weight, and adjusting the operation of the autonomous vehicle comprises decreasing at least one of: an average speed, an average cornering speed, or an average braking speed.

In another embodiment, the state of the autonomous vehicle comprises environmental operating data. In various embodiments, the environmental operating data includes at least one of: a time of day, a road condition, a traffic condition, or a location. The environmental operating data may also refer to existing weather, forecasted weather, the like.

In an embodiment, the method 400 further comprises transmitting the driving profile to a driving profile server, the driving profile server remote from the autonomous vehicle and configured to share the driving profile with other drivers.

In an embodiment, the method 400 further comprises modifying the driving profile while the autonomous vehicle is operating in autonomous mode and configuring the autonomous vehicle 104 to operate according to the driving profile when operating in autonomous mode. As discussed above, occupants of the autonomous vehicle 104, including passengers or the driver, may provide input either expressly or impliedly through their actions or reactions, which may influence the operation of the autonomous vehicle 104. For example, while operating in autonomous mode, the autonomous vehicle 104 may operate in a sporty or aggressive style. In reaction an occupant may tense up and push against the floorboards exhibiting fear or apprehension. Such behavior or response may be detected and the autonomous vehicle 104 may modify the driving style to accommodate the occupants' discomfort. The modification may be stored in the driving profile for later use, such as when the same occupants are in the vehicle at a later time.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

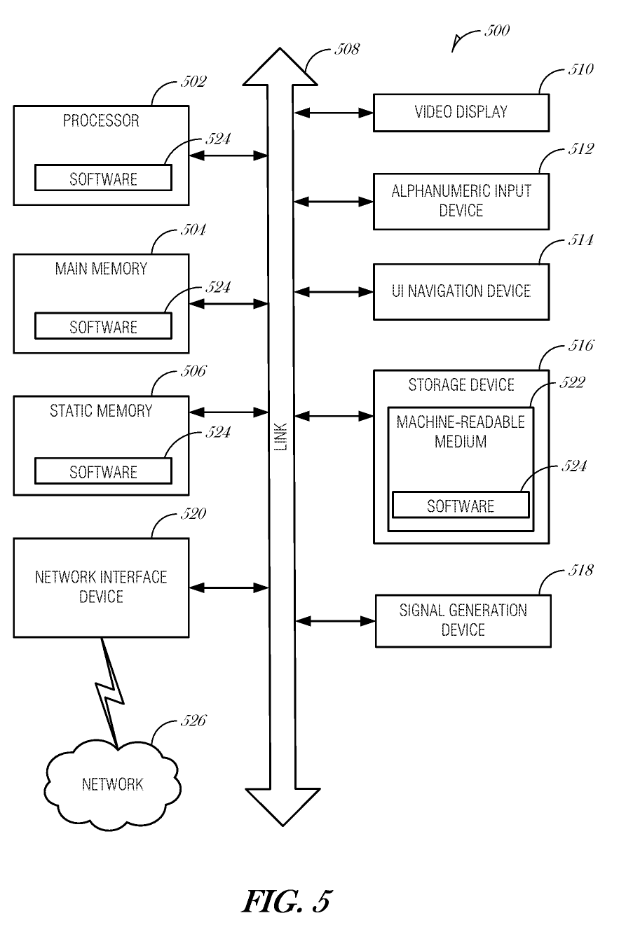

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a system for managing an autonomous vehicle, the system comprising: a driving behavior collection module to collect driving behavior of a driver while driving an autonomous vehicle in manual mode; a driving profile module to build a driving profile based on the driving behavior; and a configuration module to configure the autonomous vehicle to operate according to the driving profile when operating in autonomous mode.

In Example 2, the subject matter of Example 1 optionally includes, wherein to collect driving behavior, the driving behavior collection module is to: record a rate of acceleration of the autonomous vehicle from a stopped position; and average the rate of acceleration over a time period to obtain an average rate of acceleration.

In Example 3, the subject matter of any one or more of Examples 1-2 optionally include, wherein to collect driving behavior, the driving behavior collection module is to: record a cornering speed of the autonomous vehicle around similar type corners; and average the cornering speed over a time period to obtain an average cornering speed for the similar type corners.

In Example 4, the subject matter of any one or more of Examples 1-3 optionally include, wherein to build the driving profile, the driving profile module is to: for each of a particular driving behavior, create or modify a driving rule that operates the autonomous vehicle in a manner consistent with the particular driving behavior.

In Example 5, the subject matter of any one or more of Examples 1-4 optionally include, wherein to configure the autonomous vehicle to operate according to the driving profile when operating in autonomous mode, the configuration module is to: adjust the operation of the autonomous vehicle according to a context of the operation.

In Example 6, the subject matter of Example 5 optionally includes, wherein to adjust the operation of the autonomous vehicle according to the context of the operation, the configuration module is to: determine the context of the operation from an appointment calendar of the driver; and based on an entry in the appointment calendar, adjust the operation of the autonomous vehicle.

In Example 7, the subject matter of any one or more of Examples 5-6 optionally include, wherein to adjust the operation of the autonomous vehicle according to the context of the operation, the configuration module is to: determine the context of the operation from a behavior of an occupant of the autonomous vehicle; and based on the behavior of the occupant, adjust the operation of the autonomous vehicle.

In Example 8, the subject matter of Example 7 optionally includes, wherein the behavior of the occupant indicates that the occupant is in pain, and wherein to adjust the operation of the autonomous vehicle, the configuration module is to decrease at least one of: an average speed, an average cornering speed, or an average braking speed.

In Example 9, the subject matter of any one or more of Examples 7-8 optionally include, wherein the behavior of the occupant indicates that the occupant is nervous, and wherein to adjust the operation of the autonomous vehicle, the configuration module is to decrease at least one of: an average speed, an average cornering speed, or an average braking speed.

In Example 10, the subject matter of any one or more of Examples 7-9 optionally include, wherein to determine the context of the operation from the behavior of the occupant of the autonomous vehicle, the configuration module is to measure the behavior of the occupant using an in-vehicle sensor.

In Example 11, the subject matter of Example 10 optionally includes, wherein the in-vehicle sensor comprises a camera, and wherein to measure the behavior of the occupant, the configuration module is to: identify a facial expression, posture, or bodily reaction to an operation of the autonomous vehicle; and correlate the facial expression, posture, or bodily reaction to the behavior.

In Example 12, the subject matter of any one or more of Examples 10-11 optionally include, wherein the in-vehicle sensor comprises floorboard pressure sensors and wherein to measure the behavior of the occupant, the configuration module is to: identify a pressure profile to an operation of the autonomous vehicle; and correlate the pressure profile to the behavior.

In Example 13, the subject matter of any one or more of Examples 10-12 optionally include, wherein the in-vehicle sensor comprises a microphone and wherein to measure the behavior of the occupant, the configuration module is to: identify an utterance of the occupant; and correlate the utterance to the behavior.

In Example 14, the subject matter of any one or more of Examples 7-13 optionally include, wherein to adjust the operation of the autonomous vehicle according to the context of the operation, the configuration module is to: determine the context of the operation from an identity of an occupant of the autonomous vehicle; and based on the identity of the occupant, adjust the operation of the autonomous vehicle.

In Example 15, the subject matter of any one or more of Examples 7-14 optionally include, wherein to adjust the operation of the autonomous vehicle according to the context of the operation, the configuration module is to: determine the context of the operation from a state of the autonomous vehicle; and based on the state, adjust the operation of the autonomous vehicle.

In Example 16, the subject matter of Example 15 optionally includes, wherein the state of the autonomous vehicle comprises a current tow weight, and wherein to adjust the operation of the autonomous vehicle, the configuration module is to decrease at least one of: an average speed, an average cornering speed, or an average braking speed.

In Example 17, the subject matter of any one or more of Examples 15-16 optionally include, wherein the state of the autonomous vehicle comprises environmental operating data.

In Example 18, the subject matter of Example 17 optionally includes, wherein the environmental operating data includes at least one of: a time of day, a road condition, a traffic condition, or a location.

In Example 19, the subject matter of any one or more of Examples 1-18 optionally include, further comprising a communication module to transmit the driving profile to a driving profile server, the driving profile server remote from the autonomous vehicle and configured to share the driving profile with other drivers.

In Example 20, the subject matter of any one or more of Examples 1-19 optionally include, wherein the driving profile module is to modify the driving profile while the autonomous vehicle is operating in autonomous mode, and wherein the configuration module is to configure the autonomous vehicle to operate according to the driving profile when operating in autonomous mode.

Example 21 is a method of managing an autonomous vehicle, the method comprising: collecting driving behavior of a driver while driving an autonomous vehicle in manual mode; building a driving profile based on the driving behavior; and configuring the autonomous vehicle to operate according to the driving profile when operating in autonomous mode.

In Example 22, the subject matter of Example 21 optionally includes, wherein collecting driving behavior comprises: recording a rate of acceleration of the autonomous vehicle from a stopped position; and averaging the rate of acceleration over a time period to obtain an average rate of acceleration.

In Example 23, the subject matter of any one or more of Examples 21-22 optionally include, wherein collecting driving behavior comprises: recording a cornering speed of the autonomous vehicle around similar type corners; and averaging the cornering speed over a time period to obtain an average cornering speed for the similar type corners.

In Example 24, the subject matter of any one or more of Examples 21-23 optionally include, wherein building the driving profile comprises: for each of a particular driving behavior, creating or modifying a driving rule that operates the autonomous vehicle in a manner consistent with the particular driving behavior.

In Example 25, the subject matter of any one or more of Examples 21-24 optionally include, wherein configuring the autonomous vehicle to operate according to the driving profile when operating in autonomous mode comprises: adjusting the operation of the autonomous vehicle according to a context of the operation.

In Example 26, the subject matter of Example 25 optionally includes, wherein adjusting the operation of the autonomous vehicle according to the context of the operation comprises: determining the context of the operation from an appointment calendar of the driver; and based on an entry in the appointment calendar, adjusting the operation of the autonomous vehicle.

In Example 27, the subject matter of any one or more of Examples 25-26 optionally include, wherein adjusting the operation of the autonomous vehicle according to the context of the operation comprises: determining the context of the operation from a behavior of an occupant of the autonomous vehicle; and based on the behavior of the occupant, adjusting the operation of the autonomous vehicle.

In Example 28, the subject matter of Example 27 optionally includes, wherein the behavior of the occupant indicates that the occupant is in pain, and wherein adjusting the operation of the autonomous vehicle comprises decreasing at least one of: an average speed, an average cornering speed, or an average braking speed.

In Example 29, the subject matter of any one or more of Examples 27-28 optionally include, wherein the behavior of the occupant indicates that the occupant is nervous, and wherein adjusting the operation of the autonomous vehicle comprises decreasing at least one of: an average speed, an average cornering speed, or an average braking speed.

In Example 30, the subject matter of any one or more of Examples 27-29 optionally include, wherein determining the context of the operation from the behavior of the occupant of the autonomous vehicle comprises measuring the behavior of the occupant using an in-vehicle sensor.

In Example 31, the subject matter of Example 30 optionally includes, wherein the in-vehicle sensor comprises a camera, and wherein measuring the behavior of the occupant comprises: identifying a facial expression, posture, or bodily reaction to an operation of the autonomous vehicle; and correlating the facial expression, posture, or bodily reaction to the behavior.

In Example 32, the subject matter of any one or more of Examples 30-31 optionally include, wherein the in-vehicle sensor comprises floorboard pressure sensors and wherein measuring the behavior of the occupant comprises: identifying a pressure profile to an operation of the autonomous vehicle; and correlating the pressure profile to the behavior.

In Example 33, the subject matter of any one or more of Examples 30-32 optionally include, wherein the in-vehicle sensor comprises a microphone and wherein measuring the behavior of the occupant comprises: identifying an utterance of the occupant; and correlating the utterance to the behavior.

In Example 34, the subject matter of any one or more of Examples 27-33 optionally include, wherein adjusting the operation of the autonomous vehicle according to the context of the operation comprises: determining the context of the operation from an identity of an occupant of the autonomous vehicle; and based on the identity of the occupant, adjusting the operation of the autonomous vehicle.

In Example 35, the subject matter of any one or more of Examples 27-34 optionally include, wherein adjusting the operation of the autonomous vehicle according to the context of the operation comprises: determining the context of the operation from a state of the autonomous vehicle; and based on the state, adjusting the operation of the autonomous vehicle.

In Example 36, the subject matter of Example 35 optionally includes, wherein the state of the autonomous vehicle comprises a current tow weight, and wherein adjusting the operation of the autonomous vehicle comprises decreasing at least one of: an average speed, an average cornering speed, or an average braking speed.

In Example 37, the subject matter of any one or more of Examples 35-36 optionally include, wherein the state of the autonomous vehicle comprises environmental operating data.

In Example 38, the subject matter of Example 37 optionally includes, wherein the environmental operating data includes at least one of: a time of day, a road condition, a traffic condition, or a location.

In Example 39, the subject matter of any one or more of Examples 21-38 optionally include, further comprising transmitting the driving profile to a driving profile server, the driving profile server remote from the autonomous vehicle and configured to share the driving profile with other drivers.

In Example 40, the subject matter of any one or more of Examples 21-39 optionally include, further comprising: modifying the driving profile while the autonomous vehicle is operating in autonomous mode; and configuring the autonomous vehicle to operate according to the driving profile when operating in autonomous mode.

Example 41 is at least one machine-readable medium including instructions, which when executed by a machine, cause the machine to perform operations of any of the methods of Examples 21-40.

Example 42 is an apparatus comprising means for performing any of the methods of Examples 21-40.

Example 43 is an apparatus for managing an autonomous vehicle, the apparatus comprising: means for collecting driving behavior of a driver while driving an autonomous vehicle in manual mode; means for building a driving profile based on the driving behavior; and means for configuring the autonomous vehicle to operate according to the driving profile when operating in autonomous mode.

In Example 44, the subject matter of Example 43 optionally includes, wherein the means for collecting driving behavior comprise: means for recording a rate of acceleration of the autonomous vehicle from a stopped position; and means for averaging the rate of acceleration over a time period to obtain an average rate of acceleration.

In Example 45, the subject matter of any one or more of Examples 43-44 optionally include, wherein the means for collecting driving behavior comprise: means for recording a cornering speed of the autonomous vehicle around similar type corners; and means for averaging the cornering speed over a time period to obtain an average cornering speed for the similar type corners.

In Example 46, the subject matter of any one or more of Examples 43-45 optionally include, wherein the means for building the driving profile comprise: means for creating or modifying a driving rule that operates the autonomous vehicle in a manner consistent with each of a particular driving behavior.

In Example 47, the subject matter of any one or more of Examples 43-46 optionally include, wherein the means for configuring the autonomous vehicle to operate according to the driving profile when operating in autonomous mode comprise: means for adjusting the operation of the autonomous vehicle according to a context of the operation.

In Example 48, the subject matter of Example 47 optionally includes, wherein the means for adjusting the operation of the autonomous vehicle according to the context of the operation comprise: means for determining the context of the operation from an appointment calendar of the driver; and means for adjusting the operation of the autonomous vehicle based on an entry in the appointment calendar.

In Example 49, the subject matter of any one or more of Examples 47-48 optionally include, wherein the means for adjusting the operation of the autonomous vehicle according to the context of the operation comprise: means for determining the context of the operation from a behavior of an occupant of the autonomous vehicle; and based on the behavior of the occupant, adjusting the operation of the autonomous vehicle.

In Example 50, the subject matter of Example 49 optionally includes, wherein the behavior of the occupant indicates that the occupant is in pain, and wherein the means for adjusting the operation of the autonomous vehicle comprise means for decreasing at least one of: an average speed, an average cornering speed, or an average braking speed.

In Example 51, the subject matter of any one or more of Examples 49-50 optionally include, wherein the behavior of the occupant indicates that the occupant is nervous, and wherein the means for adjusting the operation of the autonomous vehicle comprise means for decreasing at least one of: an average speed, an average cornering speed, or an average braking speed.

In Example 52, the subject matter of any one or more of Examples 49-51 optionally include, wherein the means for determining the context of the operation from the behavior of the occupant of the autonomous vehicle comprise means for measuring the behavior of the occupant using an in-vehicle sensor.

In Example 53, the subject matter of Example 52 optionally includes, wherein the in-vehicle sensor comprises a camera, and wherein the means for measuring the behavior of the occupant comprise: means for identifying a facial expression, posture, or bodily reaction to an operation of the autonomous vehicle; and means for correlating the facial expression, posture, or bodily reaction to the behavior.

In Example 54, the subject matter of any one or more of Examples 52-53 optionally include, wherein the in-vehicle sensor comprises floorboard pressure sensors and wherein the means for measuring the behavior of the occupant comprise: means for identifying a pressure profile to an operation of the autonomous vehicle; and means for correlating the pressure profile to the behavior.

In Example 55, the subject matter of any one or more of Examples 52-54 optionally include, wherein the in-vehicle sensor comprises a microphone and wherein the means for measuring the behavior of the occupant comprise: means for identifying an utterance of the occupant; and means for correlating the utterance to the behavior.

In Example 56, the subject matter of any one or more of Examples 49-55 optionally include, wherein the means for adjusting the operation of the autonomous vehicle according to the context of the operation comprise: means for determining the context of the operation from an identity of an occupant of the autonomous vehicle; and means for adjusting the operation of the autonomous vehicle based on the identity of the occupant.

In Example 57, the subject matter of any one or more of Examples 49-56 optionally include, wherein the means for adjusting the operation of the autonomous vehicle according to the context of the operation comprise: means for determining the context of the operation from a state of the autonomous vehicle; and means for adjusting the operation of the autonomous vehicle based on the state.

In Example 58, the subject matter of Example 57 optionally includes, wherein the state of the autonomous vehicle comprises a current tow weight, and wherein the means for adjusting the operation of the autonomous vehicle comprise means for decreasing at least one of: an average speed, an average cornering speed, or an average braking speed.

In Example 59, the subject matter of any one or more of Examples 57-58 optionally include, wherein the state of the autonomous vehicle comprises environmental operating data.

In Example 60, the subject matter of Example 59 optionally includes, wherein the environmental operating data includes at least one of: a time of day, a road condition, a traffic condition, or a location.

In Example 61, the subject matter of any one or more of Examples 43-60 optionally include, further comprising means for transmitting the driving profile to a driving profile server, the driving profile server remote from the autonomous vehicle and configured to share the driving profile with other drivers.

In Example 62, the subject matter of any one or more of Examples 43-61 optionally include, further comprising: means for modifying the driving profile while the autonomous vehicle is operating in autonomous mode; and means for configuring the autonomous vehicle to operate according to the driving profile when operating in autonomous mode.

Example 63 is a system for managing an autonomous vehicle, the system comprising: a processor subsystem; and a memory including instructions, which when executed by the processor subsystem, cause the processor subsystem to: collect driving behavior of a driver while driving an autonomous vehicle in manual mode; build a driving profile based on the driving behavior; and configure the autonomous vehicle to operate according to the driving profile when operating in autonomous mode.

In Example 64, the subject matter of Example 63 optionally includes, wherein the instructions to collect driving behavior comprise instructions to: record a rate of acceleration of the autonomous vehicle from a stopped position; and average the rate of acceleration over a time period to obtain an average rate of acceleration.

In Example 65, the subject matter of any one or more of Examples 63-64 optionally include, wherein the instructions to collect driving behavior comprise instructions to: record a cornering speed of the autonomous vehicle around similar type corners; and average the cornering speed over a time period to obtain an average cornering speed for the similar type corners.

In Example 66, the subject matter of any one or more of Examples 63-65 optionally include, wherein the instructions to build the driving profile comprise instructions to: for each of a particular driving behavior, create or modify a driving rule that operates the autonomous vehicle in a manner consistent with the particular driving behavior.

In Example 67, the subject matter of any one or more of Examples 63-66 optionally include, wherein the instructions to configure the autonomous vehicle to operate according to the driving profile when operating in autonomous mode comprise instructions to: adjust the operation of the autonomous vehicle according to a context of the operation.

In Example 68, the subject matter of Example 67 optionally includes, wherein the instructions to adjust the operation of the autonomous vehicle according to the context of the operation comprise instructions to: determine the context of the operation from an appointment calendar of the driver; and based on an entry in the appointment calendar, adjust the operation of the autonomous vehicle.

In Example 69, the subject matter of any one or more of Examples 67-68 optionally include, wherein the instructions to adjust the operation of the autonomous vehicle according to the context of the operation comprise instructions to: determine the context of the operation from a behavior of an occupant of the autonomous vehicle; and based on the behavior of the occupant, adjust the operation of the autonomous vehicle.

In Example 70, the subject matter of Example 69 optionally includes, wherein the behavior of the occupant indicates that the occupant is in pain, and wherein the instructions to adjust the operation of the autonomous vehicle comprise instructions to decrease at least one of: an average speed, an average cornering speed, or an average braking speed.

In Example 71, the subject matter of any one or more of Examples 69-70 optionally include, wherein the behavior of the occupant indicates that the occupant is nervous, and wherein the instructions to adjust the operation of the autonomous vehicle comprise instructions to decrease at least one of: an average speed, an average cornering speed, or an average braking speed.

In Example 72, the subject matter of any one or more of Examples 69-71 optionally include, wherein the instructions to determine the context of the operation from the behavior of the occupant of the autonomous vehicle comprise instructions to measure the behavior of the occupant using an in-vehicle sensor.

In Example 73, the subject matter of Example 72 optionally includes, wherein the in-vehicle sensor comprises a camera, and wherein the instructions to measure the behavior of the occupant comprise instructions to: identify a facial expression, posture, or bodily reaction to an operation of the autonomous vehicle; and correlate the facial expression, posture, or bodily reaction to the behavior.

In Example 74, the subject matter of any one or more of Examples 72-73 optionally include, wherein the in-vehicle sensor comprises floorboard pressure sensors and wherein the instructions to measure the behavior of the occupant comprise instructions to: identify a pressure profile to an operation of the autonomous vehicle; and correlate the pressure profile to the behavior.

In Example 75, the subject matter of any one or more of Examples 72-74 optionally include, wherein the in-vehicle sensor comprises a microphone and wherein the instructions to measure the behavior of the occupant comprise instructions to: identify an utterance of the occupant; and correlate the utterance to the behavior.

In Example 76, the subject matter of any one or more of Examples 69-75 optionally include, wherein the instructions to adjust the operation of the autonomous vehicle according to the context of the operation comprise instructions to: determine the context of the operation from an identity of an occupant of the autonomous vehicle; and based on the identity of the occupant, adjust the operation of the autonomous vehicle.

In Example 77, the subject matter of any one or more of Examples 69-76 optionally include, wherein the instructions to adjust the operation of the autonomous vehicle according to the context of the operation comprise instructions to: determine the context of the operation from a state of the autonomous vehicle; and based on the state, adjust the operation of the autonomous vehicle.

In Example 78, the subject matter of Example 77 optionally includes, wherein the state of the autonomous vehicle comprises a current tow weight, and wherein the instructions to adjust the operation of the autonomous vehicle comprise instructions to decrease at least one of: an average speed, an average cornering speed, or an average braking speed.

In Example 79, the subject matter of any one or more of Examples 77-78 optionally include, wherein the state of the autonomous vehicle comprises environmental operating data.

In Example 80, the subject matter of Example 79 optionally includes, wherein the environmental operating data includes at least one of: a time of day, a road condition, a traffic condition, or a location.

In Example 81, the subject matter of any one or more of Examples 63-80 optionally include, further comprising instructions to transmit the driving profile to a driving profile server, the driving profile server remote from the autonomous vehicle and configured to share the driving profile with other drivers.

In Example 82, the subject matter of any one or more of Examples 63-81 optionally include, further comprising instructions to: modify the driving profile while the autonomous vehicle is operating in autonomous mode; and configure the autonomous vehicle to operate according to the driving profile when operating in autonomous mode.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for managing an autonomous vehicle, the system comprising:
a driving behavior collection module to collect driving behavior of a driver while driving an autonomous vehicle in manual mode;
a driving profile module to build a driving profile based on the driving behavior; and
a configuration module to:
configure the autonomous vehicle to operate according to the driving profile when operating in autonomous mode; and
adjust the operation of the autonomous vehicle according to a context of the operation, while operating in the autonomous mode.

2. The system of claim 1, wherein to collect driving behavior, the driving behavior collection module is to:
record a rate of acceleration of the autonomous vehicle from a stopped position; and
average the rate of acceleration over a time period to obtain an average rate of acceleration.

3. The system of claim 1, wherein to collect driving behavior, the driving behavior collection module is to:
record a cornering speed of the autonomous vehicle around similar type corners; and
average the cornering speed over a time period to obtain an average cornering speed for the similar type corners.

4. The system of claim 1, wherein to build the driving profile, the driving profile module is to:
for each of a particular driving behavior, create or modify a driving rule that operates the autonomous vehicle in a manner consistent with the particular driving behavior.

5. (canceled)

6. The system of claim 1, wherein to adjust the operation of the autonomous vehicle according to the context of the operation, the configuration module is to:
determine the context of the operation from an appointment calendar of the driver; and
based on an entry in the appointment calendar, adjust the operation of the autonomous vehicle.

7. The system of claim 1, wherein to adjust the operation of the autonomous vehicle according to the context of the operation, the configuration module is to:
determine the context of the operation from a behavior of an occupant of the autonomous vehicle; and
based on the behavior of the occupant, adjust the operation of the autonomous vehicle.

8. The system of claim 7, wherein to determine the context of the operation from the behavior of the occupant of the autonomous vehicle, the configuration module is to measure the behavior of the occupant using an in-vehicle sensor.

9. The system of claim 8, wherein the in-vehicle sensor comprises a camera, and wherein to measure the behavior of the occupant, the configuration module is to:
identify a facial expression, posture, or bodily reaction to the operation of the autonomous vehicle; and
correlate the facial expression, posture, or bodily reaction to the behavior.

10. The system of claim 8, wherein the in-vehicle sensor comprises floorboard pressure sensors and wherein to measure the behavior of the occupant, the configuration module is to:
identify a pressure profile to the operation of the autonomous vehicle; and
correlate the pressure profile to the behavior.

11. A method of managing an autonomous vehicle, the method comprising:
collecting driving behavior of a driver while driving an autonomous vehicle in manual mode;
building a driving profile based on the driving behavior;
configuring the autonomous vehicle to operate according to the driving profile when operating in autonomous mode; and
adjusting the operation of the autonomous vehicle according to a context of the operation, while operating in the autonomous mode.

12. The method of claim 11, wherein collecting driving behavior comprises:
recording a cornering speed of the autonomous vehicle around similar type corners; and
averaging the cornering speed over a time period to obtain an average cornering speed for the similar type corners.

13. The method of claim 11, wherein building the driving profile comprises:
for each of a particular driving behavior, creating or modifying a driving rule that operates the autonomous vehicle in a manner consistent with the particular driving behavior.

14. (canceled)

15. The method of claim 11, wherein adjusting the operation of the autonomous vehicle according to the context of the operation comprises:
determining the context of the operation from an appointment calendar of the driver; and
based on an entry in the appointment calendar, adjusting the operation of the autonomous vehicle.

16. The method of claim 11, wherein adjusting the operation of the autonomous vehicle according to the context of the operation comprises:
determining the context of the operation from a behavior of an occupant of the autonomous vehicle; and
based on the, behavior of the occupant, adjusting the operation of the autonomous vehicle.

17. The method of claim 16, wherein determining the context of the operation from the behavior of the occupant of the autonomous vehicle comprises measuring the behavior of the occupant using an in-vehicle sensor.

18. The method of claim 17, wherein the in-vehicle sensor comprises a microphone and wherein measuring the behavior of the occupant comprises:
identifying an utterance of the occupant; and
correlating the utterance to the behavior.

19. The method of claim 16, wherein adjusting the operation of the autonomous vehicle according to the context of the operation comprises:
determining the context of the operation from an identity of an occupant of the autonomous vehicle; and
based on the identity of the occupant, adjusting the operation of the autonomous vehicle.

20. The method of claim 16, wherein adjusting the operation of the autonomous vehicle according to the context of the operation comprises:
determining the context of the operation from a state of the autonomous vehicle; and
based on the state, adjusting the operation of the autonomous vehicle.

21. The method of claim 20, wherein the state of the autonomous vehicle comprises a current tow weight, and wherein adjusting the operation of the autonomous vehicle comprises decreasing at least one of:
an average speed, an average cornering speed, or an average braking speed.

22. The method of claim 11, further comprising transmitting the driving profile to a driving profile server, the driving profile server remote from the autonomous vehicle and configured to share the driving profile with other drivers.

23. The method of claim 11, further comprising:
modifying the driving profile while the autonomous vehicle is operating in autonomous mode; and
configuring the autonomous vehicle to operate according to the driving profile when operating in autonomous mode.

24. At least one machine-readable medium including instructions, which when executed by a machine, cause the machine to:
collect driving behavior of a driver while driving an autonomous vehicle in manual mode;
build a driving profile based on the driving behavior;
configure the autonomous vehicle to operate according to the driving profile when operating in autonomous mode; and
adjust the operation of the autonomous vehicle according to a context of the operation, while operating in the autonomous mode.

25. The at least one machine-readable medium of claim 24, wherein the instructions to build the driving profile comprise instructions to:
for each of a particular driving behavior, create or modify a driving rule that operates the autonomous vehicle in a manner consistent with the particular driving behavior.
